(19) United States
(12) Patent Application Publication
(10) Pub. No.: US 2021/0232964 A1
(43) Pub. Date: Jul. 29, 2021

(54) Method and Apparatus for Evaluating Quantum Gate in Superconducting Circuit, Device and Storage Medium

(71) Applicant: Beijing Baidu Netcom Science and Technology Co., Ltd., Beijing (CN)

(72) Inventors: Lijing JIN, Beijing (CN); Runyao DUAN, Beijing (CN)

(73) Assignee: Beijing Baidu Netcom Science and Technology Co., Ltd., Beijing (CN)

(21) Appl. No.: 17/210,950

(22) Filed: Mar. 24, 2021

(30) Foreign Application Priority Data
Jul. 15, 2020 (CN) 202010682400.0

(51) Int. Cl. G06N 10/00

(52) U.S. Cl. CPC G06N 10/00

(57) ABSTRACT

The present application discloses a method and apparatus for evaluating a quantum gate in a superconducting circuit, a device and a storage medium, which relate to the field of quantum computations. The specific scheme may include: acquiring a Hamiltonian corresponding to a superconducting circuit structure, wherein the superconducting circuit structure may include computation qubits and a coupler disposed between two of the computation qubits and coupled with the two of the computation qubits respectively; performing decoupling processing for the coupler on the Hamiltonian to obtain the processed Hamiltonian representing a coupling strength between the computation qubits; and obtaining, based on the processed Hamiltonian, a first data processing rule that takes circuit parameters of the superconducting circuit structure as input parameters, wherein a degree of a difference between a target quantum gate and a theoretical quantum gate can be obtained based on the first data processing rule.

### CROSS-REFERENCE TO RELATED APPLICATION

This application claims priority to Chinese patent application No. 202010682400.0, filed on Jul. 15, 2020, which is hereby incorporated by reference in its entirety.

### TECHNICAL FIELD

The present application relates to a field of computers, and in particular, to the field of quantum computations.

### BACKGROUND

In the process of the gradual development of superconducting quantum chips, a very natural problem and challenge is how to judge and measure the performance of a superconducting quantum chip as well as how to design the parameters of a superconducting circuit to achieve a better performance thereof.

### SUMMARY

The present application provides a method and apparatus for evaluating a quantum gate in a superconducting circuit, a device and a storage medium.

According to an aspect of the present application, there is provided a method for evaluating a quantum gate in a superconducting circuit, including:

acquiring a Hamiltonian corresponding to a superconducting circuit structure, wherein the superconducting circuit structure may include computation qubits and a coupler disposed between two of the computation qubits and coupled with the two of the computation qubits respectively, wherein a target quantum gate can be implemented based on the coupler and the computation qubits;

performing decoupling processing for the coupler on the Hamiltonian to obtain the processed Hamiltonian representing a coupling strength between the computation qubits, wherein the coupling strength may include a target coupling strength between the computation qubits for implementing the target quantum gate, and a parasitic coupling strength between the computation qubits which can cause a difference between the target quantum gate and a theoretical quantum gate; and

obtaining, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

According to another aspect of the present application, there is provided a method for evaluating a quantum gate in a superconducting circuit, including:

determining values of circuit parameters corresponding to a superconducting circuit structure to be processed, wherein the superconducting circuit structure to be processed may include computation qubits and a coupler disposed between two of the computation qubits and coupled with the two of the computation qubits respectively, wherein a target quantum gate can be implemented based on the coupler and the computation qubits; and

inputting the values of the circuit parameters corresponding to the superconducting circuit structure to be processed into the first data processing rule obtained above, so as to obtain an actual degree of difference between the target quantum gate implemented by the superconducting circuit structure to be processed and a theoretical quantum gate.

According to still another aspect of the present application, there is provided an apparatus for evaluating a quantum gate in a superconducting circuit, including:

an acquisition unit configured to acquire a Hamiltonian corresponding to a superconducting circuit structure, wherein the superconducting circuit structure may include computation qubits and a coupler disposed between two of the computation qubits and coupled with the two of the computation qubits respectively, wherein a target quantum gate can be implemented based on the coupler and the computation qubits;

a decoupling processing unit configured to perform decoupling processing for the coupler on the Hamiltonian to obtain the processed Hamiltonian representing a coupling strength between the computation qubits, wherein the coupling strength may include a target coupling strength between the computation qubits for implementing the target quantum gate, and a parasitic coupling strength between the computation qubits which can cause a difference between the target quantum gate and a theoretical quantum gate; and

a data processing rule determination unit configured to obtain, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

According to yet another aspect of the present application, there is provided an apparatus for evaluating a quantum gate in a superconducting circuit, including:

a parameter value determination unit configured to determine values of circuit parameters corresponding to a superconducting circuit structure to be processed, wherein the superconducting circuit structure to be processed may include computation qubits and a coupler disposed between two of the computation qubits and coupled with the two of the computation qubits respectively, wherein a target quantum gate can be implemented based on the coupler and the computation qubits; and

a degree of difference determination unit configured to input the values of the circuit parameters corresponding to the superconducting circuit structure to be processed into the first data processing rule obtained above, so as to obtain an actual degree of difference between the target quantum gate implemented by the superconducting circuit structure to be processed and a theoretical quantum gate.

According to yet another aspect of the present application, there is provided an electronic device, including:

at least one processor; and

a memory communicatively connected to the at least one processor, wherein,

the memory stores instructions executable by the at least one processor, the instructions being executed by the at least one processor to enable the at least one processor to perform the aforementioned first kind of method for evaluating a quantum gate in a superconducting circuit or the aforementioned second kind of method for evaluating a quantum gate in a superconducting circuit.

According to yet another aspect of the present application, there is provided a non-transitory computer-readable storage medium, which stores computer instructions for enabling a computer to perform the aforementioned first kind of method for evaluating a quantum gate in a superconducting circuit or the aforementioned second kind of method for evaluating a quantum gate in a superconducting circuit.

It should be understood that the content described in this section is neither intended to limit the key or important features of the embodiments of the present application, nor intended to limit the scope of the present application. Other features of the present application will be readily understood through the following description.

### BRIEF DESCRIPTION OF THE DRAWINGS

The drawings are used to better understand the scheme and do not constitute a limitation to the present application. In which:

FIG. 1 is a schematic diagram of a first embodiment of the present application;

FIG. 2 is a schematic diagram of a second embodiment of the present application;

FIG. 3 is a schematic diagram of a third embodiment of the present application;

FIG. 4 is a schematic diagram of a superconducting circuit structure according to an embodiment of the present application;

FIG. 5 is a flowchart of estimating a quantum gate error rate according to an embodiment of the present application;

FIG. 6 is a schematic diagram of numerical simulation results in four groups of different parameter intervals for a method according to an embodiment of the present application;

FIG. 7 is a structural diagram of a first kind of apparatus for evaluating a quantum gate in a superconducting circuit according to an embodiment of the present application;

FIG. 8 is a structural diagram of a second kind of apparatus for evaluating a quantum gate in a superconducting circuit according to an embodiment of the present application; and

FIG. 9 is a block diagram of an electronic device for implementing a first kind of method for evaluating a quantum gate in a superconducting circuit or a second kind of method for evaluating a quantum gate in a superconducting circuit according to an embodiment of the present application.

### DETAILED DESCRIPTION OF THE EMBODIMENTS

Exemplary embodiments of the present application are described below in combination with the drawings, including various details of the embodiments of the present application to facilitate understanding, which should be considered as exemplary only. Thus, those of ordinary skill in the art should realize that various changes and modifications can be made to the embodiments described here without departing from the scope and spirit of the present application. Likewise, descriptions of well-known functions and structures are omitted in the following description for clarity and conciseness.

Here, in order to effectively solve the problem that the performance of a superconducting quantum chip cannot be judged and measured at present, it is necessary to determine a measurement index, such as a quantum gate error rate, so as to represent the gap between a target quantum gate and a real quantum gate (i.e., a theoretical quantum gate). Moreover, in practical scenarios, it is sometimes unnecessary to accurately know the quantum gate error rate in quantum hardware (such as a superconducting circuit), and only needs to know a rough interval. On this basis, the scheme of the present application provides an efficient estimation method, which is very necessary and valuable to estimate a degree of a difference between the target quantum gate and the theoretical quantum gate implemented by the superconducting circuit including a coupler, such as the quantum gate error rate and the like.

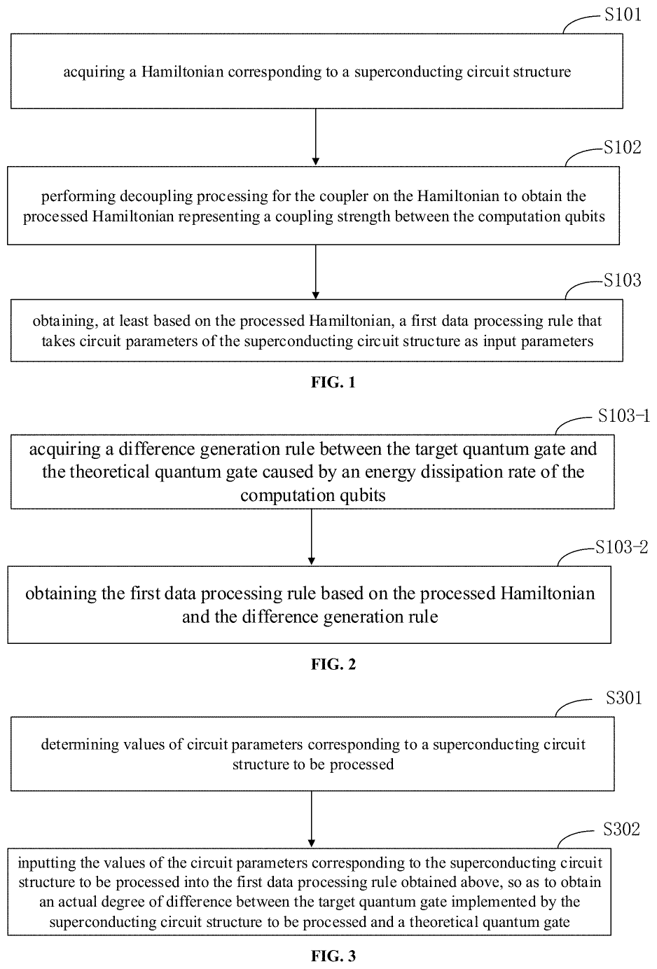

Specifically, as shown in FIG. 1, a method for evaluating a quantum gate in a superconducting circuit according to the scheme of the present application may include:

S101: acquiring a Hamiltonian corresponding to a superconducting circuit structure, wherein the superconducting circuit structure may include computation qubits and a coupler disposed between two of the computation qubits and coupled with the two of the computation qubits respectively, wherein a target quantum gate can be implemented based on the coupler and the computation qubits.

S102: performing decoupling processing for the coupler on the Hamiltonian to obtain the processed Hamiltonian representing a coupling strength between the computation qubits; wherein the coupling strength may include a target coupling strength between the computation qubits for implementing the target quantum gate, and a parasitic coupling strength between the computation qubits which can cause a difference between the target quantum gate and a theoretical quantum gate.

S103: obtaining, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

In this way, since the scheme of the present application can determine a data processing rule, such as the first data processing rule, which can effectively measure the degree of difference between the target quantum gate and the theoretical quantum gate, it effectively solves the problem that the performance of the superconducting quantum chips cannot be judged and measured because the difference between the target quantum gate and the theoretical quantum gate cannot be estimated at present, thereby filling in the blank in the prior art while providing a data support for designing the circuit parameters of the superconducting circuit.

The technology provided by the present application fills in the blank that the performance of the superconducting quantum chips cannot be efficiently judged and measured because a degree of difference between the target quantum gate and the theoretical quantum gate cannot be quickly estimated at present, and provides a data support for designing the circuit parameters of the superconducting circuit.

In a specific example of the scheme of the present application, the degree of difference represents an error rate or fidelity of the target quantum gate. In this way, the difference between the target quantum gate and the theoretical quantum gate can be effectively measured, thereby providing the data support for effectively judging and measuring the performance of the superconducting quantum chips, while providing the data support for designing the circuit parameters of the superconducting circuit.

In a specific example of the scheme of the present application, the first data processing rule may include a first difference rule between the target quantum gate and the theoretical quantum gate caused by the parasitic coupling strength between the computation qubits, so as to obtain the degree of difference between the target quantum gate and the theoretical quantum gate based on the first difference rule. In this way, through the first difference rule, the degree of difference between the target quantum gate and the theoretical quantum gate caused by the parasitic coupling strength can be obtained, which provides the data support for subsequent effective judgment and measurement of the performance of the superconducting quantum chips, while providing the data support for designing the circuit parameters of the superconducting circuit.

In a specific example of the scheme of the present application, the first data processing rule may include a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located. In this way, through the second difference rule, the degree of difference between the target quantum gate and the theoretical quantum gate caused by the energy dissipation rate can be obtained, which provides the data support for subsequent effective judgment and measurement of the performance of the superconducting quantum chips, while providing the data support for designing the circuit parameters of the superconducting circuit.

In a specific example of the scheme of the present application, S103 may include:

S103-1: acquiring a difference generation rule between the target quantum gate and the theoretical quantum gate caused by an energy dissipation rate of the computation qubits, wherein the energy dissipation rate is induced by an electromagnetic environment where the superconducting circuit structure is located, and the difference generation rule is obtained through a dynamical equation satisfied by a density matrix of the superconducting circuit structure;

S103-2: obtaining the first data processing rule based on the processed Hamiltonian and the difference generation rule, so that the first data processing rule may include a first difference rule between the target quantum gate and the theoretical quantum gate caused by the parasitic coupling strength between the computation qubits, and a second difference rule between the target quantum gate and the theoretical quantum gate caused by the energy dissipation rate of the computation qubits. That is to say, the degree of difference obtained by using the first data processing rule of this example may include not only the degree of difference between the target quantum gate and the theoretical quantum gate caused by the parasitic coupling strength, but also the degree of difference between the target quantum gate and the theoretical quantum gate caused by the energy dissipation rate, thereby improving the accuracy of the estimated degree of difference between the target quantum gate and the theoretical quantum gate, providing the data support for the subsequent effective judgment and measurement of the performance of the superconducting quantum chips, while providing the data support for designing circuit parameters of the superconducting circuit.

In a specific example of the scheme of the present application, S103-2 may include:

obtaining a second data processing rule based on the processed Hamiltonian and the difference generation rule;

determining an initial state of the superconducting circuit structure, and inputting the initial state into the second data processing rule to obtain a final state, so as to obtain the degree of difference between the target quantum gate and the theoretical quantum gate; and

solving the second data processing rule based on the degree of difference computed from the initial state, so as to obtain the first data processing rule that takes the circuit parameters as input parameters.

Here, the second data processing rule can measure the degree of difference between the target quantum gate and the theoretical quantum gate. However, since the second data processing rule is a direct expression of the Hamiltonian and the dynamical equation, i.e., the circuit parameters cannot be directly observed from the expression, the second data processing rule is solved to obtain the first data processing rule which can take the circuit parameters as input parameters, thereby improving the intuitiveness and interpretability of the processing rule for measuring the degree of difference between the target quantum gate and the theoretical quantum gate.

It should be noted that in practical applications, a plurality of initial states of the superconducting circuit structure, such as a plurality of initial states in a computation space, may be selected, and input into the second data processing rule to obtain a plurality of final states. Next, the plurality of final states are compared with a final state of the theoretical quantum gate to obtain a plurality of degrees of difference, and the average value of the plurality of degrees of difference is taken as the degree of difference between the target quantum gate and the theoretical quantum gate, so as to improve the accuracy.

The scheme of the present application also provides a method for evaluating a quantum gate in a superconducting circuit, as shown in FIG. 3, including:

S301: determining values of circuit parameters corresponding to a superconducting circuit structure to be processed, wherein the superconducting circuit structure to be processed may include computation qubits and a coupler disposed between two of the computation qubits and coupled with the two of the computation qubits respectively, wherein a target quantum gate can be implemented based on the coupler and the computation qubits;

S302: inputting the values of the circuit parameters corresponding to the superconducting circuit structure to be processed into the first data processing rule obtained above, so as to obtain an actual degree of difference between the target quantum gate implemented by the superconducting circuit structure to be processed and a theoretical quantum gate.

In a specific example of the scheme of the present application, the actual degree of difference represents a degree of a difference between the target quantum gate and the theoretical quantum gate caused by an energy dissipation rate of the computation qubits, or represents a degree of a difference between the target quantum gate and the theoretical quantum gate caused by a parasitic coupling strength between the computation qubits. Of course, the actual degree of difference may also be a sum of the degree of difference between the target quantum gate and the theoretical quantum gate caused by the energy dissipation rate of the computation qubits as well as the degree of difference between the target quantum gate and the theoretical quantum gate caused by the parasitic coupling strength between the computation qubits.

Here, it should be noted that various devices in the superconducting circuit structure to be processed in this scheme may be the same as or different from those in the superconducting circuit structure described above, as long as the superconducting circuit structure to be processed is a structure including a coupler and in which the computation qubits are coupled to each other by means of the coupler. Furthermore, in practical applications, the type of the computation qubits is not limited to the scheme of the present application, and for example, the computation qubits may be transmon qubits or Capacitively Shunted Flux Qubits (CSFQs).

In this way, the degree of difference between the target quantum gate and the theoretical quantum gate can be quickly estimated by using the first data processing rule, thereby providing a data support for efficiently measuring the performance of the superconducting quantum chips.

The scheme of the present application will be further described in detail below in combination with specific examples. Specifically, the content of the scheme of the present application will be described in detail below in three parts: I. Explanation of the problem to be solved and the scheme provided by the present application; II. Parsing of a method for estimating a quantum gate error rate by adopting relevant physical mechanisms; and III. Verification of the effect of the scheme of the present application by using a numerical simulation.

I. Method for Estimating an Error Rate of a Two-Bit Quantum Gate in a Superconducting Circuit Including a Coupler:

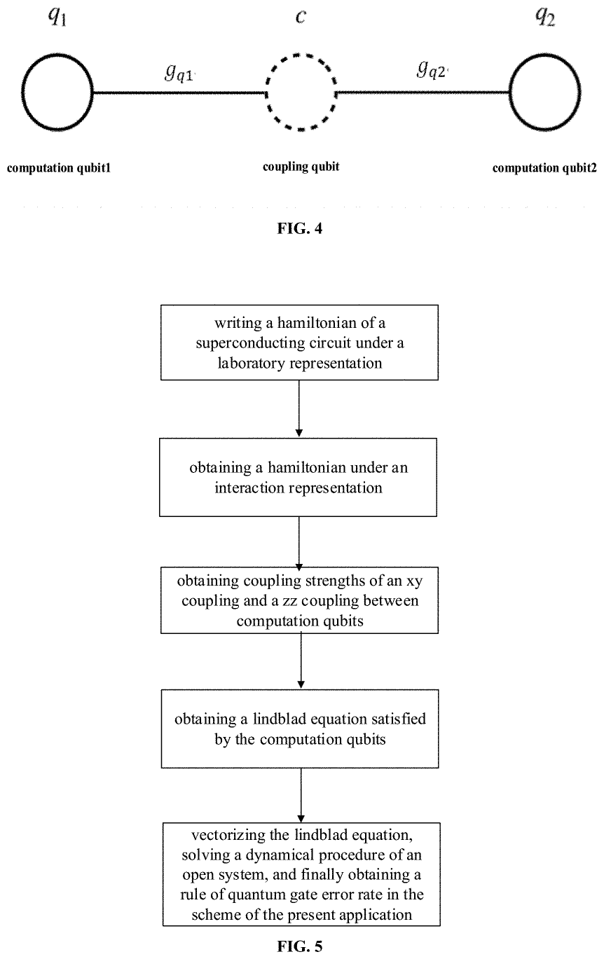

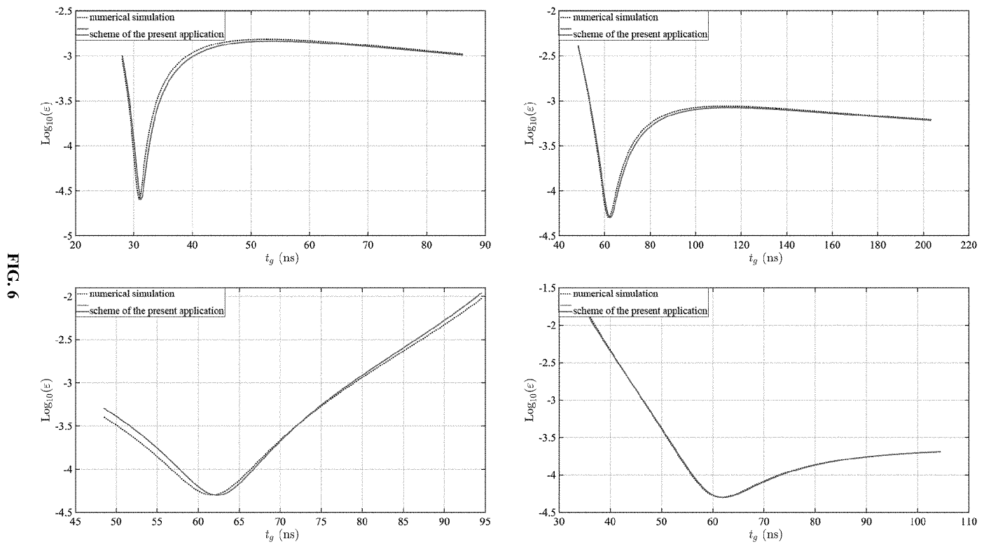

Here a superconducting circuit including a coupler, such as coupling qubits, is taken as an example. Specifically, as shown in FIG. 4, the superconducting circuit structure may include two computation qubits, i.e., a computation qubit q1 and a computation qubit q2, as well as a coupler, i.e., a coupling qubit c, and each of the computation qubits is coupled to the coupling qubit. By regulating the frequency of the coupling qubit, the coupling strength between the computation qubits can be adjusted, and also can be turned off if necessary (i.e., the coupler can also function as a switch).

Regardless of the influence of the decoherence of the computation qubits and the coupling qubit itself, the Hamiltonian describing the superconducting circuit may be written as:

$$\hat{H} = {\sum }_{k = q 1 , c , q 2} {ω}_{k} {\hat{α}}_{k}^{†} {\hat{α}}_{k} + \frac{{α}_{k}}{2} {\hat{α}}_{k}^{†} {\hat{α}}_{k}^{†} {\hat{α}}_{k} {\hat{α}}_{k} + {\sum }_{j = q 1 , q 2} {g}_{j} ( {\hat{α}}_{j}^{†} + {\hat{α}}_{j} ) ( {\hat{α}}_{c}^{†} + {\hat{α}}_{c} ) , \qquad ( 1 )$$

wherein ωₖ and αₖ represent a frequency and a detuning strength of the computation qubit (or the coupling qubits) respectively, k=q1, c, q2, and correspond to the computation qubit 1, the coupling qubit and the computation qubit 2 respectively; j=q1,q2, e.g., g_{q1} represents a coupling strength between the computation qubit 1 and the coupler, and g_{q2} represents a coupling strength between the computation qubit 2 and the coupler. In addition, âₖ^{†} and âₖ represent raising and lowering operators of the computation qubits (or the coupling qubit) respectively. In the superconducting circuit, it is required that a difference between the frequencies of the computation qubit and the coupling qubit is much greater than the coupling strength between the computation qubit and the coupling qubit, i.e., there is a dispersive coupling between the computation qubit and the coupling qubit.

For the simplicity of explanation, it is assumed that the two computation qubits are the same, i.e., ω_{q1}=ω_{q2}=ω_{q} and g_{q1}=g_{q2}=g_{q}, meanwhile, it is assumed that the energy dissipation rate of the two computation qubits and the coupling qubit is γ_{q1}=γ_{q2}=γ_{c}=γ; at this time, the above superconducting circuit structure is symmetrical. Also, it is considered that a duration t_{g} of the target quantum gate formed by the superconducting circuit structure is much shorter than a lifetime 1/γ of the computation qubit, and a strength of a ZZ parasitic coupling between the computation qubits (i.e., a change in a state of one computation qubit will influence a frequency of another computation qubit) is much smaller than that of an XY coupling (i.e., a coupling is achieved by exchanging one virtual photon between the computation qubits, so that a target quantum gate, such as an iSWAP gate or a CZ gate, is achieved). Under the above condition, in the scheme of the present application, an equation for estimating an error rate of a two-bit iSWAP gate achieved in this superconducting circuit structure is as follows:

$$∈ = {C}_{decay} γ {t}_{g} + {{C}_{ZZ} ( \frac{1}{{α}_{q 1}} + \frac{1}{{α}_{q 2}} + \frac{1}{{α}_{c} / 4 - sgn ( {ω}_{q} - {ω}_{c} ) \frac{{g}_{q 1} {g}_{q 1} {t}_{g}}{π}} )}^{2} \frac{1}{{t}_{g}^{2}} \qquad ( 2 )$$

wherein t_{g} represents a duration of the target quantum gate; both C_{decay} and C_{ZZ} are constants, and may be approximately solved as C_{decay}≈0.8 and C_{ZZ}≈18.5 respectively in the specific superconducting circuit. In addition to efficiently estimating the quantum gate error rate, the equation (2) also contains a clear physical meaning, i.e., the first item is a quantum gate error introduced by the decoherence (i.e., the energy dissipation rate) of the computation qubit itself, and the second item is a quantum gate error introduced by the ZZ parasitic coupling. Moreover, the scheme of the present application can further provide a guidance to the design of the superconducting circuit parameters, and by selecting the appropriate circuit parameters, it is expected to obtain a superconducting circuit with a target quantum gate of a low error rate. Here, it should be noted that since a fidelity=1−the error rate, the fidelity of the target quantum gate can also be obtained based on the above equation (2).

Based on the above equation (2), the scheme of the present application can directly estimate the error rate of the two-bit quantum gate as soon as the relevant parameters in the superconducting circuit, such as an energy dissipation rate, a frequency, a detuning strength, a coupling strength, a duration of a quantum gate, etc. of the computation qubit (or the coupling qubit), are known, thereby facilitating the evaluation of the performance of the superconducting quantum chip constructed therefrom. As shown in Table 1, four groups of superconducting circuit parameters (here, these parameters correspond to different types of computation qubits, respectively) are selected, and the error rate of the iSWAP quantum gate implemented by the superconducting circuit can be efficiently estimated by using the method provided by the scheme of the present application (i.e., the equation (2)).

TABLE 1

| ω_{q}/(2π) | ω_{c}/(2π) | α_{q1}/(2π) | α_{q2}/(2π) | α_{c}/(2π) | g_{q}/(2π) | 1/γ | t_{g} | Gate error |
|---|---|---|---|---|---|---|---|---|
| (GHz) | (GHz) | (MHz) | (MHz) | (MHz) | (MHz) | (μs) | (ns) | ∈ |
| 5 | 6.024 | −400 | −400 | −800 | 80 | 100 | 40 | 0.000975 |
| 5 | 5.640 | −250 | −250 | −300 | 40 | 100 | 100 | 0.000799 |
| 6 | 5.488 | −300 | −300 | 1400 | 40 | 100 | 80 | 0.00190 |
| 6 | 5.28 | 600 | 600 | 600 | 60 | 100 | 50 | 0.00529 |

II. Parsing of Solving Idea for a Quantum Gate Error Rate:

The working principle of the scheme of the present application is analyzed and explained from the perspective of the Hamiltonian of the superconducting circuit. As shown in FIG. 5, the steps of solving a quantum gate error rate are as follows.

Here, in order to more easily understand the origin of the core result (e.g., the equation (2)) of the scheme of the present application, the core steps will be briefly explained in combination with the flow as shown in FIG. 5.

Specifically, the Hamiltonian of the superconducting circuit under the laboratory representation is written, and on this basis, the coupling qubit may be decoupled by a Schiffer-Wolf transformation to obtain the coupling strength between the computation qubits. Accordingly, the Hamiltonian under the laboratory representation (the equation (1)) will be degenerated to a Hamiltonian in a computation space including only the computation qubits, i.e., a Hamiltonian under the interaction representation is obtained:

\hat{\tilde{H}}≃\tilde{g}₁₂(\hat{σ}ₓ^{q1}\hat{σ}ₓ^{q2}+\hat{σ}_{y}^{q1}\hat{σ}_{y}^{q2})+ζ_{zz}\hat{σ}_{z}^{q1}\hat{σ}_{z}^{q2} (3)

wherein \hat{σ}ₓ^{q1}, \hat{σ}_{y}^{q1}, \hat{σ}_{z}^{q1} ( [symbol] \hat{σ}ₓ^{q2}, \hat{σ}_{y}^{q2}, \hat{σ}_{z}^{q2}) are Pauli operators which describe the computation qubit 1 (or the computation qubit 2), \tilde{g}₁₂ is a coupling strength of XY coupling between two computation qubits to achieve the target quantum gate iSWAP, and ζ_{zz} is a coupling strength of ZZ coupling between the computation qubits, which belongs to parasitic coupling and will introduce noises. In this way, the coupling strengths of the XY coupling and the ZZ coupling between the computation qubits are obtained.

Here, in the above equation (3):

$$\begin{matrix}{\tilde{g}}_{12} = \frac{{g}_{q 1} {g}_{q 2}}{2} ( \frac{1}{{ω}_{q 1} - {ω}_{c}} + \frac{1}{{ω}_{q 2} - {ω}_{c}} ) , & ( 4 ) \\ {ζ}_{zz} = - 2 {( {\tilde{g}}_{12} )}^{2} ( \frac{1}{{α}_{q 1}} + \frac{1}{{α}_{q 2}} + \frac{4}{{α}_{c} - 2 ( {ω}_{q} - {ω}_{c} )} ) , & ( 5 )\end{matrix}$$

In the derivation of the above equation, a condition ω_{q1}=ω_{q2} is used. From the perspective of the physical mechanism, the above ZZ parasitic coupling results from the effect of the high energy level outside the computation space of the coupler and the superconducting qubits.

Here, in practical scenarios, the energy dissipation (i.e., the decoherency) induced by the interaction between the computation qubits themselves and the electromagnetic environment in the superconducting circuit is also an important factor of the quantum gate error rate. In consideration of this factor, the dynamical evolution procedure of the system may be described with a Lindblad equation at the moment, to obtain a Lindblad equation satisfied by the computation qubits:

$$\frac{\partial }{\partial t} \tilde{ρ} ( t ) ≃ - i [ \tilde{\hat{H}} , \tilde{ρ} ( t ) ] + {\sum }_{k = q 1 , c , q 2} {γ}_{k} [ {\hat{σ}}_{-}^{k} \tilde{ρ} ( t ) {\hat{σ}}_{+}^{k} - \frac{1}{2} {\hat{σ}}_{+}^{k} {\hat{σ}}_{-}^{k} \tilde{ρ} ( t ) - \frac{1}{2} \tilde{ρ} ( t ) {\hat{σ}}_{+}^{k} {\hat{σ}}_{-}^{k} ] , \qquad ( 6 )$$

wherein γₖ represents an energy dissipation rate of the computation qubits, and \tilde{ρ}(t) is a density matrix describing the superconducting circuit. The dynamical characteristics of the superconducting circuit may be obtained by solving a Lindlabd equation satisfied by the density matrix, i.e., the equation (6). It should be noted that the energy dissipation rate represented by γₖ may be an energy dissipation rate corresponding to the computation qubits themselves in the electromagnetic environment where the computation qubits are located, or may be an energy dissipation rate obtained after the computation qubits are influenced (i.e., corrected) by the coupler. In other words, for γₖ stated in this example, the influence of the coupler on the energy dissipation rate of the computation qubits may be considered, or may be ignored because the influence of the coupler on the energy dissipation rate of the computation qubits is relatively weak.

A dynamical procedure of an open system may be solved analytically by further vectorizing the above Lindblad equation (6), i.e., transforming the density matrix \tilde{ρ}(t) of the superconducting circuit structure into state vectors. Here, the quantum gate error rate may be solved through an idea of Quantum Process Tomography. For example, some initial states in the computation space are randomly given, and then the Lindblad equation (i.e., the equation (6)) satisfied by them is solved to obtain a final state. Subsequently, the quantum gate error rate is obtained by measuring a final state corresponding to the target quantum gate and a final state generated by the actual quantum gate (i.e., the theoretical quantum gate). Finally, the above procedure is cycled to obtain a plurality of final states, thereby obtaining a plurality of quantum gate error rates. A quantum gate error rate can be obtained by averaging the plurality of quantum gate error rates while considering two approximate conditions (a first condition is that the duration of the quantum gate is much shorter than the decoherence time of the computation qubits; and a second condition is that the ZZ parasitic coupling between the computation qubits is much weaker than the XY coupling therebetween). Further, the quantum gate error rate is utilized and the equation (6) is solved to obtain a rule of the quantum gate error rate in the scheme of the present application (i.e., the equation (2)).

III. Verification of the Effect of the Scheme of the Present Application by Using a Numerical Simulation:

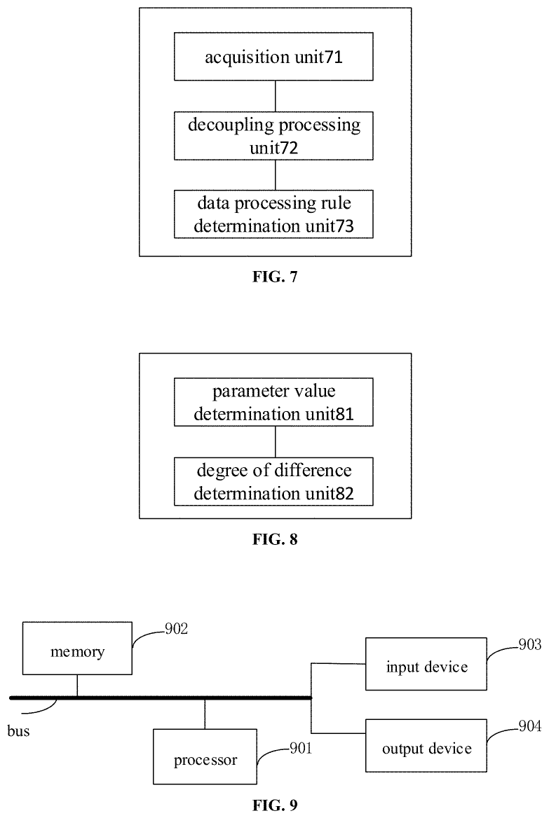

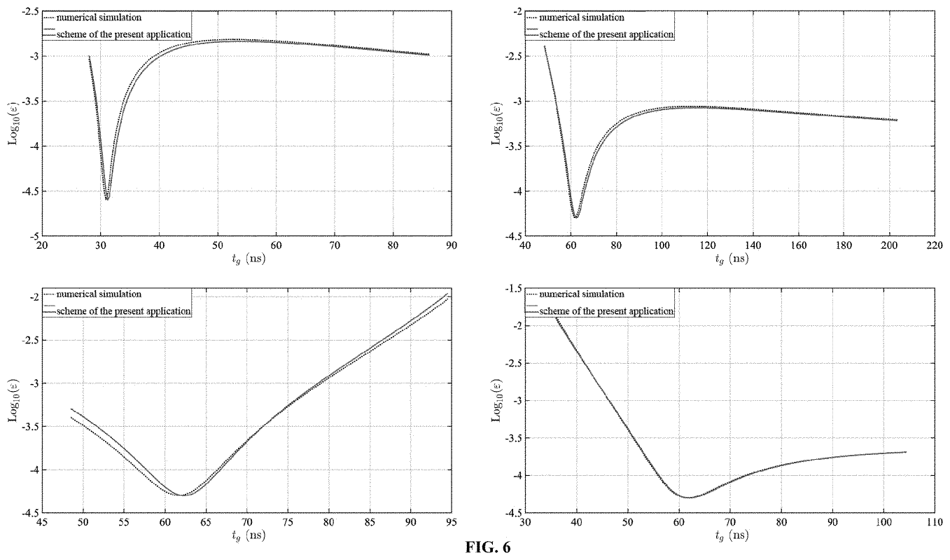

The effect of a method for estimating a quantum gate error rate in the scheme of the present application is verified by comparing a numerical simulation method with an estimation result provided by the scheme of the present application. As shown in FIG. 6 below, four groups of completely different parameter intervals (corresponding to different types of computation qubits in the industry) are selected, wherein the solid lines represent the quantum gate error rates obtained by using the method provided by the scheme of the present application, and the dotted lines represent the results of numerical simulation implemented by adopting the same system parameters. In these intervals, the estimation results given by the scheme of the present application can be coincide with the numerical results, thereby fully verifying the effectiveness of the scheme of the present application. The specific parameters are selected as follows:

Values of a first group of parameters:

ω_{q1}=ω_{q2}=5 GHz, α_{q1}=α_{q2}=−0.4 GHz, α_{c}=−0.8 GHz and g_{q1}=g_{q2}=0.08 GHz;

Values of a second group of parameters:

ω_{q1}=ω_{q2}=5 GHz, α_{q1}=α_{q2}=−0.25 GHz, α_{c}=−0.3 GHz and g_{q1}=g_{q2}=0.04 GHz;

Values of a third group of parameters:

ω_{q1}=ω_{q2}=6 GHz, α_{q1}=α_{q2}=−0.3 GHz, α_{c}=1.4 GHz and g_{q1}=g_{q2}=0.04 GHz;

Values of a fourth group of parameters:

ω_{q1}=ω_{q2}=6 GHz, α_{q1}=α_{q2}=0.6 GHz, α_{c}=0.6 GHz and g_{q1}=g_{q2}=0.06 GHz.

Based on the scheme of the present application, the quantum gate error rate of the superconducting circuit including the coupler can be estimated efficiently, simply and intuitively, thereby providing a very high application value for the estimation of the quantum gate error rate which does not pursue a high precision.

In addition, there is a guiding significance for a parameter design of the superconducting circuit including the coupler. For example, through the method provided by the scheme of the present application, reasonable circuit parameters can be selected to obtain a quantum gate with a high fidelity.

Meanwhile, the scheme of the present application has a strong expandability. In the scheme of the present application, the decoherence of the computation qubits themselves and the parasitic coupling between the computation qubits are mainly considered. Of course, in practical applications, other related noises may be considered, and the above solving idea may also be adopted. Moreover, the application scenarios may also be expanded. By adopting the idea provided by the scheme of the present application, it is also possible to support a more complex superconducting circuit or other quantum computation hardware.

Finally, since a parsing method based on the perturbation theory is adopted by the scheme of the present application, compared with the pure numerical method, the scheme of the present application not only can estimate the quantum gate error rate, but also can obtain abundant physical mechanisms in which the quantum gate error rate is induced.

The scheme of the present application also provides a first kind of apparatus for evaluating a quantum gate in a superconducting circuit, as shown in FIG. 7, including:

an acquisition unit 71 configured to acquire a Hamiltonian corresponding to a superconducting circuit structure, wherein the superconducting circuit structure may include computation qubits and a coupler disposed between two of the computation qubits and coupled with the two of the computation qubits respectively, wherein a target quantum gate can be implemented based on the coupler and the computation qubits;

a decoupling processing unit 72 configured to perform decoupling processing for the coupler on the Hamiltonian to obtain the processed Hamiltonian representing a coupling strength between the computation qubits, wherein the coupling strength may include a target coupling strength between the computation qubits for implementing the target quantum gate, and a parasitic coupling strength between the computation qubits which can cause a difference between the target quantum gate and a theoretical quantum gate; and

a data processing rule determination unit 73 configured to obtain, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

In a specific example of the scheme of the present application, the degree of difference represents an error rate or fidelity of the target quantum gate.

In a specific example of the scheme of the present application, the first data processing rule may include a first difference rule between the target quantum gate and the theoretical quantum gate caused by the parasitic coupling strength between the computation qubits, so as to obtain the degree of difference between the target quantum gate and the theoretical quantum gate based on the first difference rule.

In a specific example of the scheme of the present application, the first data processing rule may include a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located.

In a specific example of the scheme of the present application, the data processing rule determination unit may include:

an energy dissipation rate rule determination subunit configured to acquire a difference generation rule between the target quantum gate and the theoretical quantum gate caused by an energy dissipation rate of the computation qubits, wherein the energy dissipation rate is induced by an electromagnetic environment where the superconducting circuit structure is located, and the difference generation rule is obtained through a dynamical equation satisfied by a density matrix of the superconducting circuit structure; and

a first data processing rule determination subunit configured to obtain the first data processing rule based on the processed Hamiltonian and the difference generation rule, so that the first data processing rule may include a first difference rule between the target quantum gate and the theoretical quantum gate caused by the parasitic coupling strength between the computation qubits, and a second difference rule between the target quantum gate and the theoretical quantum gate caused by the energy dissipation rate of the computation qubits.

In a specific example of the scheme of the present application, the data processing rule determination unit may further include a second data processing rule determination subunit and a degree of difference determination subunit, wherein,

the second data processing rule determination subunit is configured to obtain a second data processing rule based on the processed Hamiltonian and the difference generation rule;

the degree of difference determination subunit is configured to determine an initial state of the superconducting circuit structure, and input the initial state into the second data processing rule to obtain a final state, so as to obtain the degree of difference between the target quantum gate and the theoretical quantum gate; and

the first data processing rule determination subunit is further configured to solve the second data processing rule based on the degree of difference computed from the initial state, so as to obtain the first data processing rule that takes the circuit parameters as input parameters.

The scheme of the present application further provides a second kind of apparatus for evaluating a quantum gate in a superconducting circuit, as shown in FIG. 8, including:

a parameter value determination unit 81 configured to determine values of circuit parameters corresponding to a superconducting circuit structure to be processed, wherein the superconducting circuit structure to be processed may include computation qubits and a coupler disposed between two of the computation qubits and coupled with the two of the computation qubits respectively, wherein a target quantum gate can be implemented based on the coupler and the computation qubits; and

a degree of difference determination unit 82 configured to input the values of the circuit parameters corresponding to the superconducting circuit structure to be processed into the first data processing rule obtained above, so as to obtain an actual degree of difference between the target quantum gate implemented by the superconducting circuit structure to be processed and a theoretical quantum gate.

In a specific example of the scheme of the present application, the actual degree of difference represents a degree of a difference between the target quantum gate and the theoretical quantum gate caused by an energy dissipation rate of the computation qubits, or represents a degree of a difference between the target quantum gate and the theoretical quantum gate caused by a parasitic coupling strength between the computation qubits.

In accordance with the embodiment of the present application, the present application also provides an electronic device and a readable storage medium.

FIG. 9 is a block diagram of an electronic device for implementing a first kind of method for evaluating a quantum gate in a superconducting circuit or a second kind of method for evaluating a quantum gate in a superconducting circuit according to an embodiment of the present application. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the application described and/or claimed herein.

As shown in FIG. 9, the electronic device may include one or more processors 901, a memory 902, and interfaces for connecting components, including high-speed interfaces and low-speed interfaces. The respective components are interconnected by different buses and may be mounted on a common main-board or otherwise as desired. The processor may process instructions executed within the electronic device, including instructions stored in or on the memory to display graphical information of a graphical user interface (GUI) on an external input/output device, such as a display device coupled to the interface. In other implementations, a plurality of processors and/or buses may be used with a plurality of memories, if necessary. Also, a plurality of electronic devices may be connected, each providing some of the necessary operations (e.g., as an array of servers, a set of blade servers, or a multiprocessor system). An example of a processor 901 is shown in FIG. 9.

The memory 902 is a non-transitory computer-readable storage medium provided by the present application. The memory stores instructions executable by at least one processor to cause the at least one processor to execute the first kind of method for evaluating a quantum gate in a superconducting circuit or the second kind of method for evaluating a quantum gate in a superconducting circuit provided by the present application. The non-transitory computer-readable storage medium of the present application stores computer instructions for enabling a computer to execute the first kind of method for evaluating a quantum gate in a superconducting circuit or the second kind of method for evaluating a quantum gate in a superconducting circuit provided by the present application.

The memory 902, as a non-transitory computer-readable storage medium, may be configured to store non-transitory software programs, non-transitory computer executable programs and modules, such as program instructions/modules corresponding to the first kind of method for evaluating a quantum gate in a superconducting circuit or the second kind of method for evaluating a quantum gate in a superconducting circuit in the embodiments of the present application. The processor 901 executes various functional applications and data processing of the server by running the non-transitory software programs, instructions and modules stored in the memory 902, that is, implements the first kind of method for evaluating a quantum gate in a superconducting circuit or the second kind of method for evaluating a quantum gate in a superconducting circuit in the above method embodiments.

The memory 902 may include a program storage area and a data storage area, wherein the program storage area may store an operating system, and an application program required for at least one function; and the data storage area may store data created according to the use of the electronic device for implementing the first kind of method for evaluating a quantum gate in a superconducting circuit or the second kind of method for evaluating a quantum gate in a superconducting circuit. In addition, the memory 902 may include a high speed random access memory, and may also include a non-transitory memory, such as at least one disk storage device, a flash memory device, or other non-transitory solid state storage devices. In some embodiments, the memory 902 may optionally include memories remotely located with respect to the processor 901, and these remote memories may be connected, via a network, to the electronic device for implementing the first kind of method for evaluating a quantum gate in a superconducting circuit or the second kind of method for evaluating a quantum gate in a superconducting circuit. Examples of such networks may include, but are not limited to, the Internet, an intranet, a local area network, a mobile communication network and combinations thereof.

The electronic device for implementing the first kind of method for evaluating a quantum gate in a superconducting circuit or the second kind of method for evaluating a quantum gate in a superconducting circuit may further include an input device 903 and an output device 904. The processor 901, the memory 902, the input device 903, and the output device 904 may be connected by a bus or in other ways, and the bus connection is taken as an example in FIG. 9.

The input device 903 may receive input digital or character information, and generate a key signal input related to a user setting and a functional control of electronic device for implementing the first kind of method for evaluating a quantum gate in a superconducting circuit or the second kind of method for evaluating a quantum gate in a superconducting circuit. For example, the input device may be a touch screen, a keypad, a mouse, a track pad, a touch pad, a pointer stick, one or more mouse buttons, a track ball, a joystick, and other input devices. The output device 904 may include a display apparatus, an auxiliary lighting device (e.g., a light emitting diode (LED)), a tactile feedback device (e.g., a vibrating motor), etc. The display apparatus may include, but is not limited to, a liquid crystal display (LCD), an LED display, and a plasma display. In some embodiments, the display apparatus may be a touch screen.

Various implementations of the systems and techniques described herein may be implemented in a digital electronic circuit system, an integrated circuit system, an application specific integrated circuit (ASIC), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

These computing programs (also referred to as programs, software, software applications, or codes) may include machine instructions of a programmable processor, and may be implemented using high-level procedural and/or object-oriented programming languages, and/or assembly/machine languages. As used herein, the terms “machine-readable medium” and “computer-readable medium” may refer to any computer program product, apparatus, and/or device (e.g., a magnetic disk, an optical disk, a memory, a programmable logic device (PLD)) for providing machine instructions and/or data to a programmable processor, including a machine-readable medium that receives machine instructions as machine-readable signals. The term “machine-readable signal” may refer to any signal used to provide machine instructions and/or data to a programmable processor.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other. The server may be a cloud server, also called as a cloud computing server or a cloud host, which is a host product in a cloud computing service system, to solve the defects of difficult management and weak business expansibility in the services of the traditional physical host and the virtual private server (VPS).

The technology of the present application fills in the blank that the performance of the superconducting quantum chips cannot be efficiently judged and measured because a degree of difference between the target quantum gate and the theoretical quantum gate cannot be quickly estimated at present, and provides a data support for designing the circuit parameters of the superconducting circuit.

It should be understood that the steps can be reordered, added or deleted using the various flows illustrated above. For example, the steps described in the present application may be performed concurrently, sequentially or in a different order, so long as the desired results of the technical solutions disclosed in the present application can be achieved, and there is no limitation herein.

The above-described specific embodiments do not limit the scope of the present application. It will be apparent to those skilled in the art that various modifications, combinations, sub-combinations and substitutions are possible, depending on design requirements and other factors. Any modifications, equivalent substitutions, and improvements within the spirit and principles of this application are intended to be included within the scope of this application.

What is claimed is:

1. A method for evaluating a quantum gate in a superconducting circuit, comprising:
acquiring a Hamiltonian corresponding to a superconducting circuit structure, wherein the superconducting circuit structure comprises computation qubits and a coupler disposed between two of the computation qubits and coupled with the two of the computation qubits respectively, wherein a target quantum gate can be implemented based on the coupler and the computation qubits;
performing decoupling processing for the coupler on the Hamiltonian to obtain the processed Hamiltonian representing a coupling strength between the computation qubits, wherein the coupling strength comprises a target coupling strength between the computation qubits for implementing the target quantum gate, and a parasitic coupling strength between the computation qubits which can cause a difference between the target quantum gate and a theoretical quantum gate; and
obtaining, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

2. The method according to claim 1, wherein the degree of difference represents an error rate or fidelity of the target quantum gate.

3. The method according to claim 1, wherein the first data processing rule comprises a first difference rule between the target quantum gate and the theoretical quantum gate caused by the parasitic coupling strength between the computation qubits, so as to obtain the degree of difference between the target quantum gate and the theoretical quantum gate based on the first difference rule.

4. The method according to claim 1, wherein the first data processing rule comprises a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located.

5. The method according to claim 1, wherein the obtaining, at least based on the processed Hamiltonian, the first data processing rule that takes circuit parameters of the superconducting circuit structure as input parameters, comprises:
acquiring a difference generation rule between the target quantum gate and the theoretical quantum gate caused by an energy dissipation rate of the computation qubits, wherein the energy dissipation rate is induced by an electromagnetic environment where the superconducting circuit structure is located, and the difference generation rule is obtained through a dynamical equation satisfied by a density matrix of the superconducting circuit structure; and
obtaining the first data processing rule based on the processed Hamiltonian and the difference generation rule, so that the first data processing rule comprises a first difference rule between the target quantum gate and the theoretical quantum gate caused by the parasitic coupling strength between the computation qubits, and a second difference rule between the target quantum gate and the theoretical quantum gate caused by the energy dissipation rate of the computation qubits.

6. The method according to claim 5, wherein the obtaining the first data processing rule based on the processed Hamiltonian and the difference generation rule comprises:
obtaining a second data processing rule based on the processed Hamiltonian and the difference generation rule;
determining an initial state of the superconducting circuit structure, and inputting the initial state into the second data processing rule to obtain a final state, so as to obtain the degree of difference between the target quantum gate and the theoretical quantum gate; and
solving the second data processing rule based on the degree of difference computed from the initial state, so as to obtain the first data processing rule that takes the circuit parameters as input parameters.

7. The method according to claim 3, wherein the first data processing rule comprises a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located.

8. A method for evaluating a quantum gate in a superconducting circuit, comprising:
determining values of circuit parameters corresponding to a superconducting circuit structure to be processed, wherein the superconducting circuit structure to be processed comprises computation qubits and a coupler disposed between two of the computation qubits and coupled with the two of the computation qubits respectively, wherein a target quantum gate can be implemented based on the coupler and the computation qubits; and
inputting the values of the circuit parameters corresponding to the superconducting circuit structure to be processed into the first data processing rule obtained according to claim 1, so as to obtain an actual degree of difference between the target quantum gate implemented by the superconducting circuit structure to be processed and a theoretical quantum gate.

9. The method according to claim 8, wherein the actual degree of difference represents a degree of a difference between the target quantum gate and the theoretical quantum gate caused by an energy dissipation rate of the computation qubits, or represents a degree of a difference between the target quantum gate and the theoretical quantum gate caused by a parasitic coupling strength between the computation qubits.

10. An apparatus for evaluating a quantum gate in a superconducting circuit, comprising:
a processor and a memory for storing one or more computer programs executable by the processor,
wherein when executing at least one of the computer programs, the processor is configured to perform operations comprising:
acquiring a Hamiltonian corresponding to a superconducting circuit structure, wherein the superconducting circuit structure comprises computation qubits and a coupler disposed between two of the computation qubits and coupled with the two of the computation qubits respectively, wherein a target quantum gate can be implemented based on the coupler and the computation qubits;
performing decoupling processing for the coupler on the Hamiltonian to obtain the processed Hamiltonian representing a coupling strength between the computation qubits, wherein the coupling strength comprises a target coupling strength between the computation qubits for implementing the target quantum gate, and a parasitic coupling strength between the computation qubits which can cause a difference between the target quantum gate and a theoretical quantum gate; and
obtaining, at least based on the processed Hamiltonian, a first data processing rule that takes circuit parameters of the superconducting circuit structure as input parameters, wherein a degree of difference between the target quantum gate implemented by the superconducting circuit structure and the theoretical quantum gate can be obtained based on the first data processing rule.

11. The apparatus according to claim 10, wherein the degree of difference represents an error rate or fidelity of the target quantum gate.

12. The apparatus according to claim 10, wherein the first data processing rule comprises a first difference rule between the target quantum gate and the theoretical quantum gate caused by the parasitic coupling strength between the computation qubits, so as to obtain the degree of difference between the target quantum gate and the theoretical quantum gate based on the first difference rule.

13. The apparatus according to claim 10, wherein the first data processing rule comprises a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located.

14. The apparatus according to claim 10, wherein, when executing at least one of the computer programs, the processor is configured to further perform operations comprising:
acquiring a difference generation rule between the target quantum gate and the theoretical quantum gate caused by an energy dissipation rate of the computation qubits, wherein the energy dissipation rate is induced by an electromagnetic environment where the superconducting circuit structure is located, and the difference generation rule is obtained through a dynamical equation satisfied by a density matrix of the superconducting circuit structure; and
obtaining the first data processing rule based on the processed Hamiltonian and the difference generation rule, so that the first data processing rule comprises a first difference rule between the target quantum gate and the theoretical quantum gate caused by the parasitic coupling strength between the computation qubits, and a second difference rule between the target quantum gate and the theoretical quantum gate caused by the energy dissipation rate of the computation qubits.

15. The apparatus according to claim 14, wherein, when executing at least one of the computer programs, the processor is configured to further perform operations comprising
obtaining a second data processing rule based on the processed Hamiltonian and the difference generation rule;
determining an initial state of the superconducting circuit structure, and input the initial state into the second data processing rule to obtain a final state, so as to obtain the degree of difference between the target quantum gate and the theoretical quantum gate; and
solving the second data processing rule based on the degree of difference computed from the initial state, so as to obtain the first data processing rule that takes the circuit parameters as input parameters.

16. The apparatus according to claim 12, wherein the first data processing rule comprises a second difference rule between the target quantum gate and the theoretical quantum gate caused by an energy dissipation rate of the computation qubits, so as to obtain the degree of difference between the target quantum gate and the theoretical quantum gate based on the second difference rule; wherein the energy dissipation rate is induced by an electromagnetic environment where the superconducting circuit structure is located.

17. An apparatus for evaluating a quantum gate in a superconducting circuit, comprising:
a processor and a memory for storing one or more computer programs executable by the processor,
wherein when executing at least one of the computer programs, the processor is configured to perform operations comprising:
determining values of circuit parameters corresponding to a superconducting circuit structure to be processed, wherein the superconducting circuit structure to be processed comprises computation qubits and a coupler disposed between two of the computation qubits and coupled with the two of the computation qubits respectively, wherein a target quantum gate can be implemented based on the coupler and the computation qubits; and
inputting the values of the circuit parameters corresponding to the superconducting circuit structure to be processed into the first data processing rule obtained according to claim 1, so as to obtain an actual degree of difference between the target quantum gate implemented by the superconducting circuit structure to be processed and a theoretical quantum gate.

18. The apparatus according to claim 17, wherein the actual degree of difference represents a degree of a difference between the target quantum gate and the theoretical quantum gate caused by an energy dissipation rate of the computation qubits, or represents a degree of a difference between the target quantum gate and the theoretical quantum gate caused by a parasitic coupling strength between the computation qubits.

19. A non-transitory computer-readable storage medium storing computer instructions for enabling a computer to perform the method according to claim 1.

20. A non-transitory computer-readable storage medium storing computer instructions for enabling a computer to perform the method according to claim 7.
